(19) United States
(12) Patent Application Publication
(10) Pub. No.: US 2026/0163596 A1
(43) Pub. Date: Jun. 11, 2026

(54) PASSIVE INTERMODULATION INTERFERENCE DETECTION AND MITIGATION IN CELLULAR NETWORKS

(71) Applicant: AT&T Intellectual Property I, L.P., Atlanta, GA (US)

(72) Inventors: Guanying Ru, San Ramon, CA (US); Mehdi Malboubi, San Ramon, CA (US); Ernest Tsui, Truckee, CA (US); Weihua Ye, Chicago, IL (US); Xiannuan Liang, San Ramon, CA (US)

(21) Appl. No.: 18/972,637

(22) Filed: Dec. 6, 2024

(51) Int. Cl. H04B 1/10

(52) U.S. Cl. CPC H04B 1/1027

(57) ABSTRACT

A processing system may obtain training records in a wireless communication network, each including downlink signal information, uplink noise information, and at least one label indicating whether passive intermodulation (PIM) noise is present, the set of training records being for different combinations of downlink carriers comprising a subset of less than all possible combinations. The processing system may next train a PIM noise detection model in accordance with the training records, where the model is trained to output indicators of whether instances of PIM noise are exhibited in input data samples. The processing system may then apply a first input data sample to the PIM noise detection model to obtain a first output comprising a first indication that a first instance of PIM is exhibited in the first input data sample and may perform at least one remedial action in the wireless communication network in response to the first indication.

The present disclosure relates generally to wireless communication networks, and more particularly to methods, non-transitory computer-readable media, and apparatuses for performing at least one remedial action in a wireless communication network in response to obtaining a first indication that a first instance of passive intermodulation noise is exhibited in a first input data sample in accordance with a first output of a passive intermodulation noise detection model.

### BACKGROUND

A cloud radio access network (RAN) is part of the 3^{rd} Generation Partnership Project (3GPP) fifth generation (5G) specifications for mobile networks. As part of the migration of cellular networks towards 5G, a cloud RAN may be coupled to an Evolved Packet Core (EPC) network until new cellular core networks are deployed in accordance with 5G specifications. For instance, a cellular network in a “non-stand alone” (NSA) mode architecture may include 5G radio access network components supported by a fourth generation (4G)/Long Term Evolution (LTE) core network (e.g., an EPC network). However, in a 5G “standalone” (SA) mode point-to-point or service-based architecture, components and functions of the EPC network may be replaced by a 5G core network. Ultimately, 5G may deliver superior high speed and performance.

### SUMMARY

In one example, the present disclosure discloses a method, computer-readable medium, and apparatus for performing at least one remedial action in a wireless communication network in response to obtaining a first indication that a first instance of passive intermodulation noise is exhibited in a first input data sample in accordance with a first output of a passive intermodulation noise detection model. For example, a processing system including at least one processor may obtain a set of training records in a wireless communication network, where each training record of the set of training records may include: downlink signal information, uplink noise information associated with the downlink signal information, and at least one label indicating whether passive intermodulation noise is present. In one example, the wireless communication network may utilize a plurality of downlink carriers, where the set of training records is for different combinations of downlink carriers of the plurality of downlink carriers, and where the different combinations of downlink carriers comprises a subset of less than all possible combinations of the plurality of downlink carriers. The processing system may next train a passive intermodulation noise detection model in accordance with the set of training records, where the passive intermodulation noise detection model is trained to output indicators of whether instances of passive intermodulation noise is exhibited in input data samples. The processing system may then apply a first input data sample to the passive intermodulation noise detection model to obtain a first output comprising a first indication that a first instance of passive intermodulation noise is exhibited in the first input data sample. The first input data sample may include first downlink signal information associated with a cell site of the wireless communication network and first uplink noise information associated with the first downlink signal information. The processing system may further perform at least one remedial action in the wireless communication network in response to the obtaining of the first indication that the first instance of passive intermodulation noise is exhibited in the first input data sample.

### BRIEF DESCRIPTION OF THE DRAWINGS

The teachings of the present disclosure can be readily understood by considering the following detailed description in conjunction with the accompanying drawings, in which:

FIG. 1 illustrates a block diagram of an example system, in accordance with the present disclosure;

FIG. 2 illustrates a set of example noise/interference patterns for different noise types/sources;

FIG. 3 illustrates an example PIM noise detection system in accordance with the present disclosure;

FIG. 4 illustrates a flowchart of an example method for performing at least one remedial action in a wireless communication network in response to obtaining a first indication that a first instance of passive intermodulation noise is exhibited in a first input data sample in accordance with a first output of a passive intermodulation noise detection model; and

FIG. 5 illustrates an example of a computing device, or computing system, specifically programmed to perform the steps, functions, blocks, and/or operations described herein.

To facilitate understanding, similar reference numerals have been used, where possible, to designate elements that are common to the figures.

### DETAILED DESCRIPTION

The present disclosure broadly discloses methods, computer-readable media, and apparatuses for performing at least one remedial action in a wireless communication network in response to obtaining a first indication that a first instance of passive intermodulation noise is exhibited in a first input data sample in accordance with a first output of a passive intermodulation noise detection model. In particular, passive intermodulation (PIM) interference (or PIM noise) may show up as a set of unwanted signals created by the mixing of two or more strong radio frequency signals in a nonlinear device (e.g., a loose or corroded connector, nearby rust, etc.). For example, downlink signals (e.g., with high transmission power from a macro base station) of Band 14 and Band 17 can inter modulate and generate PIM noise that falls into the uplink of Band 17 and/or Band 14. In addition, the uplink in a frequency division duplex (FDD) system can be highly sensitive, e.g., since the uplink signals from endpoint devices/user equipment (UE) may have a maximum transmission power of approximately 23 dBm, along with path loss and degradation. Therefore, PIM interference may cause a significant increase in the uplink noise floor, which in turn can degrade cellular network quality and coverage.

To fix PIM interference issues in the field may involve antenna repair or replacement. Therefore, some locations may include expensive tower climbs with certified tower climbing technicians, on-site test, and so forth. The detection of PIM interference/noise may also be challenging where a cell site without PIM noise can later experience PIM noise issues due to the changing environment. For example, nonlinear junctions can change with humidity, moisture (rain and snow), and result in slowly increasing corrosion. It should also be noted that the existence and strength of the PIM interference can be intermittent/sporadic and may vary with network load condition, or may have various patterns that depend on the sources. In addition, different PIM noise sources can generate variant PIM features. Furthermore, the characteristics of PIM noise are not trivial, especially where PIM noise/interference may be mixed with other interference types. Thus, various rule-based methods for PIM noise detection may fail or may be inaccurate. For example, linear-regression may capture simple patterns but may suffer from a high rate of false alarms. Nevertheless, PIM noise remains a dominant uplink interference issue that can affect thousands of cells and significantly degrade cell coverage and user experience.

Examples of the present disclosure include machine learning (ML)-based automatic PIM noise/interference detection that employs automatic label generation for model training data. It is generally known that odd order harmonics of a nonlinearity (for example, caused by dissimilar surface junctions) can cause PIM noise/interference across a variety of carrier frequencies. The combinations of possible frequencies and harmonics in a wireless network (e.g., a carrier network) are numerous and thus difficult to identify precisely. Existing PIM interference counters may measure a PIM noise signature in a partial loading scenario, e.g., where a cell site (or an antenna, array, and/or sector thereof) does not transmit power in every possible frequency available for use. On the other hand, existing PIM noise testing systems may extract PIM noise signatures in a full loading scenario or for several partial loading scenarios (e.g., at a cell site, sector, antenna, array, etc.).

In all of these cases, the present disclosure may obtain training data that is labeled with respect to whether PIM noise is present or not. However, between these two sources of data, there are still generalized PIM noise responses that are not tested for different carrier combinations (only the “all carrier” test). Nevertheless, the ML-based examples of the present disclosure may be applied to detect PIM noise/interference with respect to untested spectrum combinations (e.g., carrier or sub-carrier combinations, frequency channel combinations, etc.), new carriers (e.g., new frequency bands, sub-bands, frequency channels, etc.), and/or for other wireless operators (which may utilize different spectrum). For instance, in one example fundamental PIM noise equations may be used along with the spectral interference patterns (e.g., magnitude of interference/noise as a function of frequencies and time) to infer causal effect (e.g., for detected PIM noise, identifying which carriers are involved and what order PIM noise, e.g., second order, third order, etc.). For instance, Equation 1 illustrates the input data:

x(t,f)=S1+S2+ . . . +Sk Equation 1:

In this equation, S1, S2 . . . . Sk represent the downlink signal power at different frequencies, channels, carriers, sub-carriers or the like, and x(t,f) represents the observed power in the uplink (e.g., which may contain uplink noise of one or more sources, and which may be referred to herein as uplink noise information).

Equation 2 characterizes the non-linear output of a PIM noise source:

Y(t,f)=F{x}˜g+a*x+b*x³+c*x⁵ Equation 2:

It should be noted that this equation represents an odd-order example only, where harmonics appear at selected frequencies of interest and time, t, averaged over observation time intervals, e.g., 1 minute intervals, 15 minute intervals, 30 minute intervals, 1 hour intervals, or the like. The x parameter depends on the cellular network operator's carrier allocations and F{x} or a, b, c, and g depend on PIM noise nonlinearity (e.g., these differ among antennas/radios, environments, and possibly loading (magnitudes of Si)). In one example, the goal may be to solve for Si (e.g., carriers, sub-carriers, or the like) that contribute to the observations (time intervals, frequency, and magnitude) of Y(t,f).

In one example, a PIM noise testing system such as mentioned above may generate full load test scenarios (e.g., magnitude=1 normalized for the unique cell/sector transmit power for Si for S1 . . . , Sk) and may derive the resulting Y(f) (averaged over a one minute measurement interval, or the like). In view of the foregoing, in one example a machine learning model of the present disclosure may then be tasked with identifying the Si(s) that contribute to the observed noise. In one example, an interference threshold, such as >−115 dBm, may be applied to make sure the PIM interference level is high enough to warrant notification, tracking, or other remedial actions.

Examples of the present disclosure may include various combinations of carrier, sub-carriers, or the like in one or more frequency/spectrum bands. For instance, example combinations may include Personal Communications Service (PCS)-to-PCS PIM noise, Advanced Wireless Services (AWS)-to-AWS PIM noise, PCS and AWS-to-AWS or PCS PIM noise, and so forth. In one example, extensive test data may be collected from example bands using example channel spacing, e.g., Band 14 and Band 17 10 MHz cells, in which PIM noise is highly prevalent by nature. In one example, modeling based on test data such as from Band 14 and Band 17 may then be used to extend into other bands and/or cells using different channel bandwidths. When sufficient test data is available from these other bands and/or channel bandwidths, the model(s) may be retrained and/or new models may be trained for those cases. It should also be noted that in various examples, the uplink observed power/uplink noise information may be with respect to a physical uplink control channel (PUCCH) and/or a physical uplink shared channel (PUSCH) (and in some examples, further with respect to different granularities, e.g., per PRB level, or the like).

Having large scale and reliable labeling is a non-trivial task that is addressed through examples of the present disclosure. For instance, as noted above, the present disclosure may use an on-demand remote PIM noise testing tool which artificially load carriers and accurately determines whether PIM noise appears during the test window. Since this tool is actively used, human labeling is largely avoided and replaced with automated labeling. From the fundamental understanding of how PIM noise is generated, PIM noise can be exhibited in the uplink interference pattern in the frequency domain. In addition, the PIM noise pattern may be related to band and bandwidth information. Therefore, these related information elements may be used as the ML input features. In just two examples, trained machine learning model (MLM) of the present disclosure may comprise a random forest model or a convolutional neural network (CNN) model, both of which are capable of achieving high PIM noise detection accuracy.

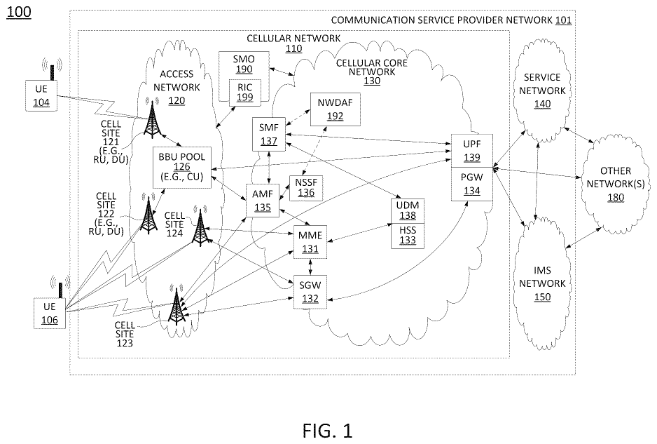

Examples of the present disclosure may adapt to various PIM noise patterns and are capable of accurate PIM noise detected in the presence of other types of interference. For instance, using balanced samples of both PIM noise and no PIM noise, an overall accuracy of greater than 95% is demonstrated. In one example, a machine learning model of the present disclosure may be updated periodically, e.g., monthly, quarterly, etc. to embrace new samples and in some cases to capture new features. Likewise, a machine learning model of the present disclosure may adapt and may be extended to new bands, such as C-band and other future bands when sufficient (but still incomplete) samples may be collected. In one example, the present disclosure may use synthetic training data automatically generated from existing training data, e.g., to fill in gaps in the actual measured/observed training data with respect to downlink carrier/channel frequency combinations having no samples and/or sparse sampling. In one example, the automated machine learning-based PIM noise detection of the present disclosure may be deployed to perform network-wide (e.g., nationwide) ongoing monitoring of PIM noise occurrences in a manner that is non-intrusive to the network. In one example, self-optimizing network (SON)-based PIM mitigation may be triggered by examples of the present disclosure to automatically address PIM noise occurrences. These and other aspects of the present disclosure are discussed in greater detail below in connection with the examples of FIGS. 1-5.

To better understand the present disclosure, FIG. 1 illustrates an example network, or system 100 in which examples of the present disclosure may operate. In one example, the system 100 includes a communication service provider network 101. The communication service provider network 101 may comprise a cellular network 110 (e.g., a 4G/Long Term Evolution (LTE) network, a 4G/5G hybrid network, or the like), a service network 140, and an IP Multimedia Subsystem (IMS) network 150. The system 100 may further include other networks 180 connected to the communication service provider network 101.

In one example, the cellular network 110 comprises an access network 120 and a cellular core network 130. In one example, the access network 120 comprises a cloud RAN. For instance, a cloud RAN is part of the 3GPP 5G specifications for mobile networks. As part of the migration of cellular networks towards 5G, a cloud RAN may be coupled to an Evolved Packet Core (EPC) network until new cellular core networks are deployed in accordance with 5G specifications. In one example, access network 120 may include cell sites 121 and 122 and a baseband unit (BBU) pool 126. In a cloud RAN, radio frequency (RF) components, referred to as remote radio heads (RRHs), may be deployed remotely from baseband units, e.g., atop cell site masts, buildings, and so forth. In an Open RAN (O-RAN) architecture, these may alternatively or additionally be referred to as and/or may include radio units (RUS) (also referred to as O-RUs) and/or distributed units (DUs). In one example, the BBU pool 126 may be located at distances as far as 20-80 kilometers or more away from the antennas/remote radio heads of cell sites 121 and 122 that are serviced by the BBU pool 126. In an O-RAN architecture, these may alternatively or additionally be referred to as and/or may include centralized units (CUs). It should also be noted in accordance with efforts to migrate to 5G networks, cell sites may be deployed with new antenna and radio infrastructures such as multiple input multiple output (MIMO) antennas, and millimeter wave antennas. In this regard, a cell, e.g., the footprint or coverage area of a cell site may in some instances be smaller than the coverage provided by NodeBs or eNodeBs of 3G-4G RAN infrastructure. For example, the coverage of a cell site utilizing one or more millimeter wave antennas may be 1000 feet or less.

Although cloud RAN and or O-RAN infrastructure may include distributed units (DUs), radio units (RUs)/RRHs and centralized units (CU), e.g., baseband units (BBUs), a heterogeneous network may include cell sites where RRH and BBU components (or CUs, DUs, and RUs) remain co-located at the cell site. For instance, cell site 123 may include RRH and BBU components (or an RU, DU, and CU). Thus, cell site 123 may comprise a self-contained “base station.” With regard to cell sites 121 and 122, the “base stations” may comprise RRHs at cell sites 121 and 122 coupled with respective baseband units of BBU pool 126. In accordance with the present disclosure, any one or more of cell sites 121-123 may be deployed with antenna and radio infrastructures, including multiple input multiple output (MIMO) and millimeter wave antennas.

In one example, access network 120 may include both 4G/LTE and 5G radio access network infrastructure. For example, access network 120 may include cell site 124, which may comprise 4G/LTE base station equipment, e.g., an eNodeB. In addition, access network 120 may include cell sites comprising both 4G and 5G base station equipment, e.g., respective antennas, feed networks, baseband equipment, and so forth. For instance, cell site 123 may include both 4G and 5G base station equipment and corresponding connections to 4G and 5G components in cellular core network 130. Although access network 120 is illustrated as including both 4G and 5G components, in another example, 4G and 5G components may be considered to be contained within different access networks. Nevertheless, such different access networks may have a same wireless coverage area, or fully or partially overlapping coverage areas.

In one example, the cellular core network 130 provides various functions that support wireless services in the LTE environment. In one example, cellular core network 130 is an Internet Protocol (IP) packet core network that supports both real-time and non-real-time service delivery across a LTE network, e.g., as specified by the 3GPP standards. In one example, cell sites 121 and 122 in the access network 120 are in communication with the cellular core network 130 via baseband units in BBU pool 126. In cellular core network 130, network devices such as Mobility Management Entity (MME) 131 and Serving Gateway (SGW) 132 support various functions as part of the cellular network 110. For example, MME 131 is the control node for LTE access network components, e.g., eNodeB aspects of cell sites 121-123. In one embodiment, MME 131 is responsible for UE (User Equipment) tracking and paging (e.g., such as retransmissions), bearer activation and deactivation process, selection of the SGW, and authentication of a user. In one embodiment, SGW 132 routes and forwards user data packets, while also acting as the mobility anchor for the user plane during inter-cell handovers and as an anchor for mobility between 5G, LTE and other wireless technologies, such as 2G and 3G wireless networks.

In addition, cellular core network 130 may comprise a Home Subscriber Server (HSS) 133 that contains subscription-related information (e.g., subscriber profiles), performs authentication and authorization of a wireless service user, and provides information about the subscriber's location. The cellular core network 130 may also comprise a packet data network (PDN) gateway (PGW) 134 which serves as a gateway that provides access between the cellular core network 130 and various packet data networks (PDNs), e.g., service network 140, IMS network 150, other network(s) 180, and the like.

The foregoing describes long term evolution (LTE) cellular core network components (e.g., EPC components). In accordance with the present disclosure, cellular core network 130 may further include other types of wireless network components e.g., 2G network components, 3G network components, 5G network components, etc. Thus, cellular core network 130 may comprise an integrated network, e.g., including any two or more of 2G-5G infrastructures and technologies, and the like. For example, as illustrated in FIG. 1, cellular core network 130 further comprises 5G components, including: an access and mobility management function (AMF) 135, a network slice selection function (NSSF) 136, a session management function (SMF), a unified data management function (UDM) 138, a user plane function (UPF) 139, and a network data analytics function (NWDAF) 192.

In one example, AMF 135 may perform registration management, connection management, endpoint device reachability management, mobility management, access authentication and authorization, security anchoring, security context management, coordination with non-5G components, e.g., MME 131, and so forth. NSSF 136 may select a network slice or network slices to serve an endpoint device, or may indicate one or more network slices that are permitted to be selected to serve an endpoint device. For instance, in one example, AMF 135 may query NSSF 136 for one or more network slices in response to a request from an endpoint device (such as UE 104 or UE 106) to establish a session to communicate with a PDN. The NSSF 136 may provide the selection to AMF 135, or may provide one or more permitted network slices to AMF 135, where AMF 135 may select the network slice from among the choices. A network slice may comprise a set of cellular network components, e.g., network functions (NFs), such as AMF(s), SMF(s), UPF(s), and so forth that may be arranged into different network slices which may logically be considered to be separate cellular networks. A specific set of NFs arranged into a network slice may also be referred to as a network slice instance (NSI). In one example, different network slices may be preferentially utilized for different types of services. For instance, a first network slice may be utilized for sensor data communications, Internet of Things (IoT), and machine-type communication (MTC), a second network slice may be used for streaming video services, a third network slice may be utilized for voice calling, a fourth network slice may be used for gaming services, a fifth network slice may be used for first responder or other governmental services, and so forth.

In one example, SMF 137 may perform endpoint device IP address management, UPF selection, UPF configuration for endpoint device traffic routing to an external packet data network (PDN), charging data collection, quality of service (QoS) enforcement, and so forth. In one example, UDM 138 may perform user identification, credential processing, access authorization, registration management, mobility management, subscription management, and so forth. As illustrated in FIG. 1, UDM 138 may be tightly coupled to HSS 133. For instance, UDM 138 and HSS 133 may be co-located on a single host device, or may share a same processing system comprising one or more host devices. In one example, UDM 138 and HSS 133 may comprise interfaces for accessing the same or substantially similar information stored in a database on a same shared device or one or more different devices, such as subscription information, endpoint device capability information, endpoint device location information, and so forth. For instance, in one example, UDM 138 and HSS 133 may both access subscription information or the like that is stored in a unified data repository (UDR) (not shown).

UPF 139 may provide an interconnection point to one or more external packet data networks (PDN(s)) and perform packet routing and forwarding, QoS enforcement, traffic shaping, packet inspection, and so forth. In one example, UPF 139 may also comprise a mobility anchor point for 4G-to-5G and 5G-to-4G session transfers. In this regard, it should be noted that UPF 139 and PGW 134 may provide the same or substantially similar functions, and in one example, may comprise the same device, or may share a same processing system comprising one or more host devices.

As noted above, cellular core network 130 further includes NWDAF 192, which may be tasked monitoring various network functions, network slices, and access network components. In one example, NWDAF 192 may subscribe to data analytics (e.g., performance indicators/KPIs) from a variety of NFs, may store these analytics, and may provide such analytics to other NFs that may request such data. In accordance with the present disclosure, NWDAF 192 may track various performance indicators with respect to access network 120 and/or regarding particular components thereof (such as RUs, DUs, CU, etc., e.g., cell sites 121 and 122, BBU pool 125, cell sites 123 and 124, and so forth).

To illustrate, in one example, NWDAF 192 may collect and store downlink signal information e.g., for cell sites, sectors, or the like. NWDAF 192 may also collect and store uplink noise information, e.g., associated with the same cell sites, sectors, etc. In one example, NWDAF 192 may associate aspects of the downlink signal information with corresponding aspects of the uplink noise information. For example, downlink signal information and uplink noise information may be time-stamped. In one example, NWDAF 192 may aggregate the downlink signal information and uplink noise information into respective records with labels indicating whether PIM noise is present. In one example, NWDAF 192 may obtain and store records from an automated PIM noise testing system, e.g., records of time, downlink signal information, and uplink noise information labeled with an indicator of PIM noise or no PIM noise. In one example, the time information may also include a date (e.g., where seasonality may be factor in predicting/identifying PIM noise, e.g., which may be correlated to weather/environmental factors such as temperature, humidity, precipitation, etc.). In one example, NWDAF 192 may also collect and store other relevant data in such records, or in connection with such records. For example, each record may also include information identifying the cell, sector, antenna, and/or antenna array, the equipment type (e.g., antenna and/or feed network manufacturer, make, model, etc.), a location (e.g., latitude, longitude, and/or elevation), a type of deployment, e.g., rooftop, standalone, etc., and so forth. In one example, NWDAF 192 may also collect and store external/third-party data, such as weather data (e.g., temperature, humidity, precipitation indication, precipitation volume, etc.) that may also be used in connection with PIM detection. In accordance with the present disclosure, NWDAF 192 may also train and store one or more PIM noise detection models. For instance, the PIM noise detection model(s) may each comprise a machine learning model.

It should be noted that as referred to herein, a machine learning model (MLM) (or machine learning-based model) may comprise a machine learning algorithm (MLA) that has been “trained” or configured in accordance with input training data to perform a particular service. For instance, a MLM may comprise a deep learning neural network, or deep neural network (DNN), a convolutional neural network (CNN), a recurrent neural network (RNN), a long-short term memory (LSTM) model, a transformer network, an encoder-decoder neural network, an encoder neural network, a decoder neural network, a variational autoencoder, a generative adversarial network (GAN), a decision tree algorithm/model, such as gradient boosted decision tree (GBDT) (e.g., XGBoost, XGBR, or the like), and so forth. In one example, one or more MLMs of the present disclosure may include supervised learning and/or reinforcement learning (e.g., using positive and negative examples after deployment as a MLM), and so forth. In one example, MLAs/MLMs of the present disclosure may be in accordance with an open source library, such as OpenCV, which may be further enhanced with domain-specific training data.

In one example, the PIM noise detection model(s) may include a random forest model or a CNN model. To further illustrate, in one particular example, a PIM noise detection model of the present disclosure may comprise a one-dimensional CNN (1dCNN). In addition, in one particular example, such a 1dCNN may comprise a concatenated model that includes one convolutional layer with 16 filters of kernel size 25 that takes input vectors of uplink noise as a function of time and frequency. For training purposes, the input vectors may be associated with PIM noise labels as noted above. A dense layer (e.g., operating as a classifier) may be fed the output(s) of the convolutional layer, and in one example may have an additional input of cell band as a categorical input. The CNN model may also include one or more pooling layers (e.g., a max pooling layer) and/or a dense layer/fully-connected layer. Similarly, in another example, a random forest model may be built using the same or similar input vectors as noted above. In one example, cell band may also be used as an additional categorical input. Notably, random forest models may operate by constructing a multitude of independent decision trees at training time and outputting the class that is the mode of the classes of the individual trees. Trees can capture complex interactions in the data. In addition, sufficiently grown trees may have relatively low bias, while averaging may reduce noisiness associated with trees.

In one example, with respect to any of the PIM noise detection model types (e.g., different types of MLMs), the present disclosure may apply various pre-processing operations with respect to the training data and/or runtime data that is used for live PIM noise detection. For instance, in one example, the present disclosure may apply a noise threshold to records in which PIM may be indicated. In other words, there may be some level of PIM present in many antenna systems. However, the power density may be so low as to have insignificant impact on wireless data communications. As such, these records may be labeled as no-PIM or insignificant PIM, while only those records indicative of PIM having a magnitude over a threshold may be labeled as PIM or significant PIM (e.g., >−115 dBm, or the like). In other examples, thresholding may be applied to focus on those cells that are affected by the most significant PIM noise, where the threshold(s) may be adjusted later to capture more cells that are affected by PIM. Other pre-processing techniques may include sampling, down-sampling, up-sampling, averaging, smoothing, correlation with other network performance indicators, dimension reduction, etc. In addition, in one example, NWDAF 192 may implement synthetic data generation techniques to obtain additional synthetic training data samples for training the one or more PIM noise detection models.

In one example, NWDAF 192 may train and deploy one or more such PIM noise detection models. For example, NWDAF 192 may train and deploy different PIM noise detection models for different geographic regions or climate types (e.g., coastal versus non-coastal, tundra versus desert, etc.), for different tracking areas, for different equipment types, for different deployment types (e.g., rooftop versus non-rooftop/standalone), and so on. Alternatively, or in addition, these factors may comprise additional inputs/predictors for a trained MLM, where the MLM may learn and generate outputs based upon the relevance of these different inputs/predictors.

To further illustrate, NWDAF 192 may obtain a new input vector comprising downlink signal information and uplink noise information associated with cell site 121. NWDAF 192 may then apply a PIM noise detection model to the new input vector to generate an output indicating whether PIM noise is or is not present/exhibited in the input vector data. In one example, the PIM noise detection model may further output the likely frequencies causing the PIM noise (e.g., identified by carrier, sub-carrier, frequency channel (e.g., center frequency or frequency range), or the like). In one example, additional inputs, such as weather information, equipment type, etc. may influence how the PIM noise detection model may process the new input vector and may ultimately influence the output indicating whether PIM is detected (and/or the causal frequencies/frequency ranges). In another example, one or more of the additional factors such as mentioned above may be used to select an appropriate PIM noise detection model from among a plurality of PIM noise detection models (e.g., a model for a “desert location” versus a model for a “temperate coastal location,” etc.).

In one example, NWDAF 192 may further store the results/outputs of the one or more PIM noise detection models in response to various input data samples/vectors. In one example, NWDAF 192 may provide individual or aggregate reports to one or more other NFs, e.g., on a subscription basis and/or on-demand. For instance, SMO 190 and/or RIC 199 thereof may obtain PIM noise alerts, reports, or the like from NWDAF 192, and may use such information to automatically configure/reconfigure one or more aspects of cell site 121 and/or access network 120. Likewise, in one example NWDAF 192 may provide alerts, reports, or the like to one or more endpoint devices of network personnel, e.g., for manual investigation, troubleshooting, and/or remediation, for network planning, and so forth.

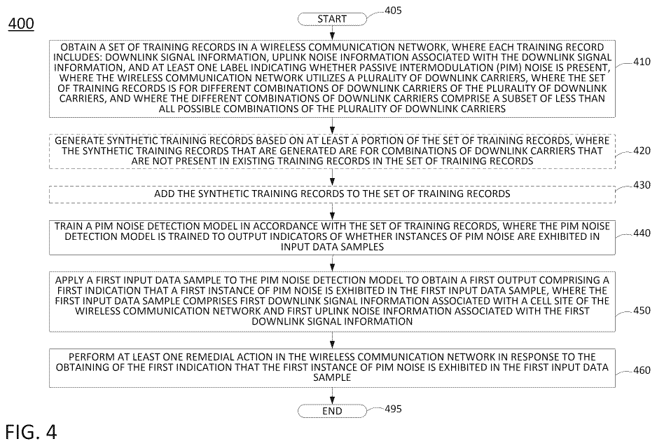

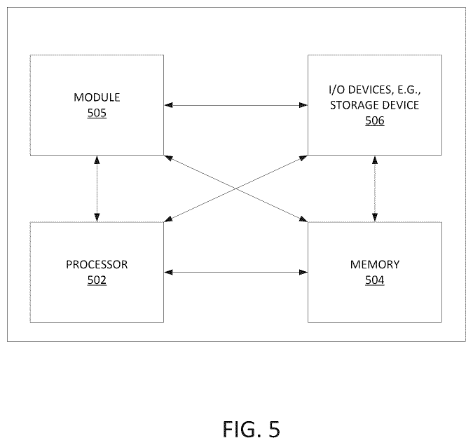

In one example, aspects of the present disclosure for performing at least one remedial action in a wireless communication network in response to obtaining a first indication that a first instance of passive intermodulation noise is exhibited in a first input data sample in accordance with a first output of a passive intermodulation noise detection model, e.g., as described in greater detail below in connection with the example method 400 of FIG. 4, may be performed by NWDAF 192. In this regard, in one example, NWDAF 192 may comprise all or a portion of a computing device or system, such as computing system 500, and/or processing system 502 as described in connection with FIG. 5 below, and may be configured to perform various operations in connection with examples of the present disclosure for performing at least one remedial action in a wireless communication network in response to obtaining a first indication that a first instance of passive intermodulation noise is exhibited in a first input data sample in accordance with a first output of a passive intermodulation noise detection model. In addition, it should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 5 and discussed below) or multiple computing devices collectively configured to perform various steps, functions, and/or operations in accordance with the present disclosure.

It should be noted that other examples may comprise a cellular network with a “non-stand alone” (NSA) mode architecture where 5G radio access network components, such as a “new radio” (NR), “gNodeB” (or “gNB”), and so forth are supported by a 4G/LTE core network (e.g., an EPC network), or a 5G “standalone” (SA) mode point-to-point or service-based architecture where components and functions of an EPC network are replaced by a 5G core network (e.g., an “NC”). For instance, in non-standalone (NSA) mode architecture, LTE radio equipment may continue to be used for cell signaling and management communications, while user data may rely upon a 5G new radio (NR), including millimeter wave communications, for example. However, examples of the present disclosure relate to a hybrid, or integrated 4G/LTE-5G cellular core network such as cellular core network 130 illustrated in FIG. 1. In this regard, FIG. 1 illustrates a connection between AMF 135 and MME 131, e.g., an “N26” interface which may convey signaling between AMF 135 and MME 131 relating to endpoint device tracking as endpoint devices are served via 4G or 5G components, respectively, signaling relating to handovers between 4G and 5G components, and so forth.

In one example, service network 140 may comprise one or more devices for providing services to subscribers, customers, and or users. For example, communication service provider network 101 may provide a cloud storage service, web server hosting, and other services. As such, service network 140 may represent aspects of communication service provider network 101 where infrastructure for supporting such services may be deployed. In one example, other networks 180 may represent one or more enterprise networks, a circuit switched network (e.g., a public switched telephone network (PSTN)), a cable network, a digital subscriber line (DSL) network, a metropolitan area network (MAN), an Internet service provider (ISP) network, and the like. In one example, the other networks 180 may include different types of networks. In another example, the other networks 180 may be the same type of network. In one example, the other networks 180 may represent the Internet in general. In this regard, it should be noted that any one or more of service network 140, other networks 180, or IMS network 150 may comprise a packet data network (PDN) to which an endpoint device may establish a connection via cellular core network 130 in accordance with the present disclosure.

FIG. 1 also illustrates various endpoint devices, e.g., user equipment (UE) 104 and 106. UE 104 and UE 106 may each comprise a cellular telephone, a smartphone, a tablet computing device, a laptop computer, a pair of computing glasses, a wireless enabled wristwatch, a wireless transceiver for a fixed wireless broadband (FWB) deployment, or any other cellular-capable mobile telephony and computing device (broadly, “an endpoint device”). In one example, each of the UE 104 and UE 106 may each be equipped with one or more directional antennas, or antenna arrays (e.g., having a half-power azimuthal beamwidth of 120 degrees or less, 90 degrees or less, 60 degrees or less, etc.), e.g., MIMO antenna(s) to receive multi-path and/or spatial diversity signals. Each of the UE 104 and UE 106 may also include a gyroscope and compass to determine orientation(s), a global positioning system (GPS) receiver for determining a location, and so forth. As illustrated in FIG. 1, UE 104 may access wireless services via the cell site 121, while UE 106 may access wireless services via any of cell sites 122-124 located in the access network 120.

In one example, any one or more of the components of cellular core network 130 may comprise network function virtualization infrastructure (NFVI), e.g., SDN host devices (i.e., physical devices) configured to operate as various virtual network functions (VNFs), such as a virtual MME (vMME), a virtual HHS (vHSS), a virtual serving gateway (vSGW), a virtual packet data network gateway (vPGW), and so forth. For instance, MME 131 may comprise a vMME, SGW 132 may comprise a vSGW, and so forth. Similarly, AMF 135, NSSF 136, SMF 137, UDM 138, NWDAF 192, and/or UPF 139 may also comprise NFVI configured to operate as VNFs. In addition, when comprised of various NFVI, the cellular core network 130 may be expanded (or contracted) to include more or less components than the state of cellular core network 130 that is illustrated in FIG. 1.

In this regard, the cellular network 110 may also include a service and management orchestrator (SMO) 190. For instance, in one example, SMO 190 may comprise a self-optimizing network (SON) orchestrator and/or software defined network (SDN) controller. To illustrate, SMO 190 may function as a self-optimizing network (SON) orchestrator that is responsible for activating and deactivating, allocating and deallocating, and otherwise managing a variety of network components. For instance, SMO 190 may activate and deactivate antennas/remote radio heads of cell sites 121 and 122, respectively, may allocate and deactivate baseband units in BBU pool 126, and may perform other operations for activating antennas based upon a location and a movement of an endpoint device or a group of endpoint devices, in accordance with the present disclosure.

In one example, SMO 190 may further comprise a SDN controller that is responsible for instantiating, configuring, managing, and releasing VNFs. For example, in a SDN architecture, a SDN controller may instantiate VNFs on shared hardware, e.g., NFVI/host devices/SDN nodes, which may be physically located in various places. In one example, the configuring, releasing, and reconfiguring of SDN nodes is controlled by the SDN controller, which may store configuration codes, e.g., computer/processor-executable programs, instructions, or the like for various functions which can be loaded onto an SDN node. In another example, the SDN controller may instruct, or request an SDN node to retrieve appropriate configuration codes from a network-based repository, e.g., a storage device, to relieve the SDN controller from having to store and transfer configuration codes for various functions to the SDN nodes.

Accordingly, the SMO 190 may be connected directly or indirectly to any one or more network elements of cellular core network 130, access network 120, and of the system 100 in general. Due to the relatively large number of connections available between SMO 190 and other network elements, none of the actual links to the SON/SDN controller 190 are shown in FIG. 1. Similarly, intermediate devices and links between MME 131, SGW 132, cell sites 121-124, PGW 134, AMF 135, NSSF 136, SMF 137, UDM 138, NWDAF 192, and/or UPF 139, and other components of system 100 are also omitted for clarity, such as additional routers, switches, gateways, and the like.

In one example, SMO 190 may include a RAN intelligent controller (RAN-IC or RIC) 199. For instance, in an O-RAN architecture, the RIC 199 may be deployed for managing and controlling various RAN components/functions, e.g., CUs, DUs, and RUs. For instance, RIC 199 may comprise a platform that hosts various RAN applications (e.g., xApps/rApps) that may be used to configure and reconfigure various components of access network 120. In one example, aspects of RIC 199 may represent functionality of an SON orchestrator, or vice versa. In one example, RIC 199 and/or SMO 190 may request and/or subscribe to various information that may be obtained and stored by NWDAF 192. Such information may include time-stamped RAN performance indicators (e.g., KPIs for various time blocks/intervals), RAN environment state information (e.g., RAN parameters and/or settings associated with the time blocks/intervals for which performance indicators may be measured/collected), or the like. Alternatively, or in addition RIC 199 and/or SMO 190 may obtain various information from RAN components or other network elements directly (e.g., without NWDAF 192 as an intermediary).

In one particular example, as noted above SMO 190 may subscribe to or otherwise obtain PIM noise information from NWDAF 192. The PIM noise information may comprise alerts of detected PIM noise for particular cells, sectors, antennas, antenna arrays, or the like. In one example, the PIM noise information may include identifications of the downlink frequencies causing the PIM noise and/or the uplink frequency or frequencies in which the PIM noise is exhibited (e.g., identified by the frequencies and/or frequency ranges, channel identifier(s), PRB identifier(s), or the like), the PIM noise order (e.g., second order, third order, etc.), the magnitude of the PIM noise (and/or magnitudes in a range of frequencies), and so forth. Alternatively, or in addition, the PIM noise information may comprise aggregate reports for a cell, sector, tracking area, etc. Similarly, in one example, the PIM noise information may include reports for one or more cells, sectors, etc. over a time period, e.g., a weekly report, a monthly report, etc. For instance, a report may list the total number of time intervals screened, the number of time intervals detected with PIM noise, the uplink noise level, e.g., per branch, PUCCH, and/or PUSCH, uplink noise branch delta, e.g., maximum versus minimum, first versus second, etc., or the like.

In addition, SMO 190 and/or RIC 199 may then configure/reconfigure one or more aspects of access network 120, cellular core network 130, and/or one or more network slices deployed over the infrastructure of access network 120 and cellular core network 130 in response to the obtained PIM noise information. In one example, aspects of the present disclosure for performing at least one remedial action in a wireless communication network in response to obtaining a first indication that a first instance of passive intermodulation noise is exhibited in a first input data sample in accordance with a first output of a passive intermodulation noise detection model, e.g., as described in greater detail below in connection with the example method 400 of FIG. 4, may be performed by RIC 199 and/or SMO 190. In this regard, in one example, RIC 199 and/or SMO 190 may comprise all or a portion of a computing device or system, such as computing system 500, and/or processing system 502 as described in connection with FIG. 5 below, and may be configured to perform various operations in connection with examples of the present disclosure for performing at least one remedial action in a wireless communication network in response to obtaining a first indication that a first instance of passive intermodulation noise is exhibited in a first input data sample in accordance with a first output of a passive intermodulation noise detection model. In this regard, it should also be noted that in some examples, aspects described herein with respect to NWDAF 192 may alternatively or additionally be performed by SMO 190 and/or RIC 199. For instance, in one example, SMO 190 may implement one or more PIM noise detection models. To further illustrate, NWDAF 192 may collect and store time stamped records of downlink signal information and uplink noise information. SMO 190 and/or RIC 199 may then obtain these records and may apply the records to one or more PIM noise detection models in accordance with the present disclosure to detect PIM noise. In addition, SMO 190 and/or RIC 199 may then configure/reconfigure one or more aspects of network 120, cell site 121, etc. in response to the PIM noise that is detected. For instance, SMO 190 and/or RIC 199 may transmit instructions to a base station to reduce transmit power in one or more downlink frequencies, carriers, sub-carriers, frequency channels, PRBs, or the like, to omit or reduce utilization of one or more uplink frequencies carriers, sub-carriers, frequency channels, PRBs, or the like, and so forth. Alternatively, or in addition, SMO 190 and/or RIC 199 may transmit instructions to a base station to perform beam steering, e.g., to direct a null in a direction of external PIM, and so forth.

In one example, NWDAF 192, SMO 190, and/or RIC 199 thereof may be in communication with one or more other systems that may be involved in PIM noise detection and/or mitigation. For example, upon detection of PIM noise via a PIM detection model in accordance with the present disclosure, NWDAF 192 may alert an active probing system to collect more samples with respect to a particular cell, sector, etc., to apply one or more heuristics/algorithms that may be configured to perform active diagnostics at a cell site to distinguish between external PIM noise and internal PIM, and so forth. it should also be noted that although aspects of the present disclosure are described primarily in connection with NWDAF 192, SMO 190, and RIC 199, in other, further, and different examples, aspects of the present disclosure may alternatively or additionally be deployed in a different manner. For instance, in another example, aspects of the present disclosure for performing at least one remedial action in a wireless communication network in response to obtaining a first indication that a first instance of passive intermodulation noise is exhibited in a first input data sample in accordance with a first output of a passive intermodulation noise detection model, e.g., as described in greater detail below in connection with the example method 400 of FIG. 4, may alternatively or additionally be deployed in one or more servers, network functions, host devices, containers, etc. that may be independent of an NWDAF, a SMO, a RIC, etc. Likewise, such a PIM noise detection and remediation system may be deployed in public cloud infrastructure, on-premises, e.g., in communication service provider network 101 (e.g., in a private cloud, premises), in an edge cloud (e.g., specifically in an access network, such as access network 120), and so forth.

The foregoing description of the system 100 is provided as an illustrative example only. In other words, the example of system 100 is merely illustrative of one network configuration that is suitable for implementing embodiments of the present disclosure. As such, other logical and/or physical arrangements for the system 100 may be implemented in accordance with the present disclosure. For example, the system 100 may be expanded to include additional networks, such as network operations center (NOC) networks, additional access networks, and so forth. The system 100 may also be expanded to include additional network elements such as border elements, routers, switches, policy servers, security devices, gateways, a content distribution network (CDN) and the like, without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements.

For instance, in one example, the cellular core network 130 may further include a Diameter routing agent (DRA) which may be engaged in the proper routing of messages between other elements within cellular core network 130, and with other components of the system 100, such as a call session control function (CSCF) (not shown) in IMS network 150. In another example, the NSSF 136 may be integrated within the AMF 135. In addition, cellular core network 130 may also include additional 5G NG core components, such as: a policy control function (PCF), an authentication server function (AUSF), a network repository function (NRF), and other application functions (AFs).

In one example, any one or more of cell sites 121-124 may comprise 2G, 3G, 4G and/or LTE radios, e.g., in addition to 5G new radio (NR), or gNB functionality. For instance, cell site 123 is illustrated as being in communication with AMF 135 in addition to MME 131 and SGW 132. It should be noted that the example described above involves a 4G-to-5G PDN connection transfer (and 5G-to-4G reversion) that includes UE 106 transferring from cell site 124 to cell site 122 (and vice versa). However, in another example, UE 106 may establish a 4G session to a PDN via 4G/LTE components of cell site 123, and may be transferred to a 5G connection via 5G components of the same cell site 123 in response to one or more trigger conditions as described above.

In addition, network elements or functions that are illustrating as being deployed in one portion of the communication service provider network 101 may alternatively or additionally be deployed in another portion of the communication service provider network 101. For example, SMO 190 may be deployed in cellular core network 130, within access network 120, or may comprise a distributed computing platform having hardware components within cellular core network 130 and access network 120. Thus, these and other modifications are all contemplated within the scope of the present disclosure.

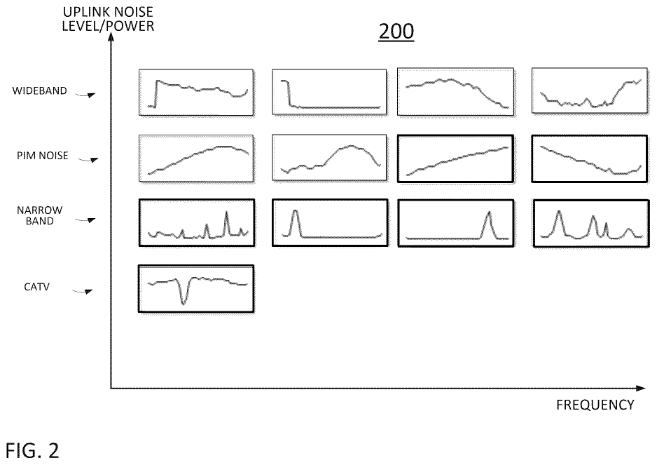

To further aid in understanding the present disclosure, FIG. 2 illustrates a set 200 of example noise/interference patterns for different noise types/sources, e.g., wideband interference, PIM noise/interference, narrowband interference, and cable television (CATV) interference. Notably, each of the different types of interference may exhibit different patterns, which may all be mixed with each other in terms of a total uplink noise/power density distribution. In addition, even within each of the particular types of interference, different patterns may still be exhibited. For example, among the PIM noise patterns, there is substantial variation among individual patterns, which may be associated with different equipment vendors, different PIM noise sources/types, e.g., internal PIM noise sources, external PIM noise sources, different downlink frequencies involved, different downlink transmit power(s) involved, and so forth. The multitude of different patterns, along with the prevalence of multiple different concurrent noise sources being simultaneously present renders it challenging to identify when PIM noise in particular is present. For instance, heuristic based methods may be designed in awareness of these factors, but may fail to separate PIM noise from other sources, or may over-detect many false positives.

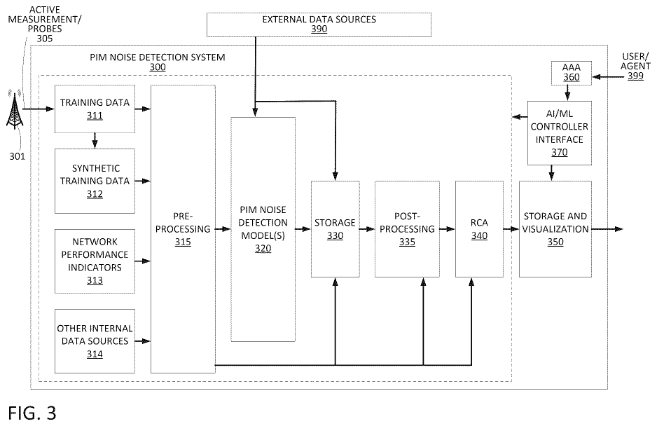

FIG. 3 illustrates an example PIM noise detection system 300 in accordance with the present disclosure. In one example, the PIM noise detection system 300 may comprise a processing system (e.g., including at least one processor as well as memory, storage, etc.) to implement the described modules/functionality. To illustrate, the PIM noise detection system 300 may obtain training data 311 from a radio access network (RAN) 301. For instance, active measurement probes 305 may be used to collect ground-truth data and signatures for training the model. These may include observations in a live RAN 301 and/or test loading within RAN 301, e.g., using all available carriers or the like. PIM noise detection system 300 may further generate synthetic training data 312. For instance, generative AI/ML approaches may be used to create cost effective synthetic “ground truth” data (e.g., using the training data 311 as model input(s)) to be used along with the actual measured training data 311. As noted above, the training data may include time stamped downlink signal information and uplink noise information. PIM noise detection system 300 may also collect/obtain other network performance indicators 313 that may be used as additional factors of ML-based PIM noise detection. As illustrated in FIG. 3, the PIM noise detection system 300 may further include a pre-processing module 315 that may apply various types of pre-processing to enhance the input features and the performance of the PIM noise detection model(s) 320, such as data cleansing, averaging, sampling, and so forth.

The core of the PIM noise detection system 300 may comprise one or more PIM noise detection model(s) 320. For instance, PIM noise detection model(s) 320 may include one or more reconfigurable AI/ML model(s) with the ability of adaptive re-training/fine-tuning via AI/ML controller interface 370. The PIM noise detection model(s) 320 can be developed using confidential-computing platforms or federated ML techniques and in collaboration with external data-sources. Storage 330 may store the input data (e.g., training data 311, synthetic training data 312, etc.), the outputs of PIM noise detection model(s) 320, and auxiliary data, such as data from external data source(s) 390. Post-processing module 335 may include functionality of PIM noise detection system 300 for applying various post-processing techniques such as thresholding, anonymization, etc. In one example, such post-processing may include ranking and prioritizing the output of the model. For instance, based on the UL interference level, how often it is detected with PIM noise within the monitoring window, likelihood of PIM noise existence, as well as one or more network performance indicator values (e.g., containing correlations between UL interference and network performance, etc.), the functionality of post-processing module 335 may cause the PIM nose detection system to prioritize instances of detected PIM noise for remediation. To further illustrate, PIM noise that is more severe, affects an area with more users/endpoint devices, affects areas with locations, entities, structures, etc. with high importance (such as police and fire stations, first responder facilities, transit hubs, etc.), and so forth may be ranked with greater priority in terms of additional resources that may be subsequently assigned to further address the PIM noise, such as root cause analysis, site visits, etc. In one example, the particular techniques may be selected/configured via the AI/ML controller interface 370.

The root-cause analysis (RCA) module 340 may include functionality of PIM noise detection system 300 for processing and analyze the outputs of the PIM noise detection model(s) 320 to determine the possible root-cause(s) of detected PIM noise and to recommend resolutions to resolve the issue(s). In one example, RCA module 340 may include adaptive interaction with the AI/ML controller interface 370 and/or the user, or agent 399, e.g., via the authentication, authorization, and accounting (AAA) module 360. The storage and visualization module 350 may store the output(s) of the PIM noise detection model(s) 320 and the results of the analysis of RCA module 340. In addition, the storage and visualization module may include functionality of PIM noise detection system 300 to appropriately render, display, or otherwise visualize the results for the user/agent 399.

In one example, the AI/ML controller interface 370 may comprise a generative artificial intelligence (gen-AI) agent that may be trained/fine-tuned/enhanced using pertinent internal and external documents/data. For example, such an agent may control and reconfigure the other modules/components of PIM noise detection system 300 to improve the performance of the PIM noise detection model(s) to satisfy user preferences of the user/agent 399 (e.g., changing thresholds of PIM noise detection model(s) 320 to reduce the technician-dispatch rate and to focus on the most critical cells, etc.), and so forth. The AAA module 360 may provide authentication, authorization, and accounting services for internal and external users. The interaction of the PIM noise detection system 300 with internal data sources and external data source(s) 390 may be via appropriate and secure application programming interfaces (APIs), physical interfaces, buses, etc. The external data sources may include, for example, weather data sources, such as really simple syndication (RSS) weather data feed(s) or the like, event data sources, e.g., news feeds or the like, which may indicate mass gathering events that may cause spikes in network traffic/load such as major sporting events, concerts, etc., and so forth.

It should be noted that FIG. 3 and the foregoing description is just one example configuration of a PIM noise detection system 300 in accordance with the present disclosure. Thus, it should be understood that other, further, and different examples may include more or less components, different components, or other modifications. For instance, in one example, storage 330 may be omitted and all storage may be via the storage and visualization module 350. In one example, RCA module 340 may be omitted. For instance, PIM noise detection system 300 may generate outputs of PIM noise detection model(s) 320, which may be provided to one or more other automated systems, which may include RCA functionality to perform further active tests in the network for root cause determination. In one example, pre-processing module 315 may further include functionality for segregating data for training and benchmarking the performance metrics of PIM noise detection model(s) 320, and so on. Thus, these and other modifications are all contemplated within the scope of the present disclosure.

FIG. 4 illustrates a flowchart of an example method 400 for performing at least one remedial action in a wireless communication network in response to obtaining a first indication that a first instance of passive intermodulation noise is exhibited in a first input data sample in accordance with a first output of a passive intermodulation noise detection model, in accordance with the present disclosure. In one example, steps, functions and/or operations of the method 400 may be performed by a device as illustrated in FIG. 1, e.g., NWDAF 192, SMO 190, and/or RIC 199, or any one or more components thereof, such as a processing system, or collectively via a plurality devices in FIG. 1, such as NWDAF 192, SMO 190, and/or RIC 199 in conjunction with another one or more of NWDAF 192, SMO 190, and/or RIC 199, in conjunction with cell sites 121 and 122, BBU pool 126, and so forth. In one example, the steps, functions, or operations of method 400 may be performed by a computing device or system 500, and/or a processing system 502 as described in connection with FIG. 5 below. For instance, the computing device 500 may represent at least a portion of SMO 190 and/or RIC 199 in accordance with the present disclosure. For illustrative purposes, the method 400 is described in greater detail below in connection with an example performed by a processing system, such as processing system 502. The method 400 begins in step 405 and proceeds to step 410.

At step 410, the processing system obtains a set of training records in a wireless communication network. In one example, each training record of the set of training records may include: downlink signal information, uplink noise information associated with the downlink signal information, and at least one label indicating whether PIM noise is present. For instance, the wireless communication network may utilize a plurality of downlink carriers, where the set of training records may be for different combinations of downlink carriers, and where the different combinations of downlink carriers may include a subset of less than all possible combinations of the downlink carriers. In one example, the downlink signal information may comprise a downlink signal information set that includes a plurality of downlink signal frequency information identifiers. For example, the set of training records may be for different combinations of downlink carriers, which may be indicated in the downlink signal frequency information identifiers. In various examples, the plurality of downlink signal frequency information identifiers may include two or more channel frequencies, two or more frequencies ranges that define two or more channels, two or more sub-carrier range identifiers, and/or two or more physical resource block (PRB) identifiers (which may inherently include sub-carrier identification information), or the like. In one example, the downlink signal information set may include two or more downlink signal magnitudes associated with the two or more downlink signal frequency information identifiers. For example, the magnitude can be measured in amplitude/power, e.g., milliwatt, Watt, etc., dBm (decibels relative to one milliwatt), or the like.

Similarly, in one example, the uplink noise information may comprise an uplink noise information set that includes: one or more uplink frequency information identifiers and one or more uplink noise magnitudes associated with the one or more uplink frequency information identifiers. For instance, the one or more uplink frequency information identifiers may include: one or more channel frequencies, one or more frequencies ranges that define one or more channels, one or more sub-carrier range identifiers, one or more PRB identifiers, or the like. Likewise, uplink noise magnitude can be measured in amplitude/power. In one example, the uplink noise information may be associated with a physical uplink shared channel, a physical uplink control channel, or the like. In one example, where the at least one label may indicate that an instance of PIM noise is present, the at least one label may further identify at least one frequency of the PIM noise (e.g., at least one uplink frequency that is affected by the PIM noise).

In one example, the set of training records may be obtained from observations in at least a portion of the wireless communication network. For instance, the set of training records may be obtained from active network measurement probes and/or passive network measurements in at least a portion of the wireless communication network. In one example, the at least the portion of the wireless communication network may comprise a sector, a cell site (e.g., the same cell site from which the first input data sample is obtained at subsequent step 440), or a tracking area (e.g., the same tracking area in which the cell site from which the first input data sample is obtained is also located), or one or more different cell sites, tracking areas, etc. To further illustrate, the set of training records (or aspects thereof) may be obtained from respective RAN components (e.g., from one or more CUs, DUs, and/or RUs (or RRHs and/or BBUs), etc.) and/or from one or more cellular core network components (e.g., from an AMF or SMF, from an NWDAF, etc.).

In another example, the at least the portion of the wireless communication network may comprise cell sites associated with equipment of a same type. In still another example, the at least the portion of the wireless communication network may comprise cell sites associated with similar environmental conditions. For instance, the similarity of environmental conditions may be assigned according to user labels, or according to a similarity metric based upon measures of a plurality of environmental conditions. In other words, in various examples, there may be different PIM noise detection models for these different portions of the wireless communication network. Thus, the training data may be specific to the network portion. However, in another example, a PIM noise detection model may learn differences based upon any of the foregoing factors and may account for these differences in the model training.

At optional step 420, the processing system may generate synthetic training records based on at least a portion of the set of training records, where the synthetic training records that are generated are for combinations of the downlink carriers that are not present in existing training records in the set of training records. For example, in some cases, the wireless communication network may lack available data for certain cells, sectors, tracking areas, etc. In one example, the processing system may use data from other portions of the network. For instance, the processing system may use generative AI/ML (e.g., a generative adversarial network (GAN) or the like) to generate synthetic data to train the primary PIM noise detection model at step 440.

At optional step 430, the processing system may add the synthetic training records to the set of training records. For instance, these records may be stored together for use at the following step 440.

At step 440, the processing system trains a PIM noise detection model in accordance with the set of training records. For example, the PIM noise detection model may be trained to output indicators of whether instances of PIM noise is exhibited in input data samples (e.g., comprising downlink signal information and uplink noise information associated with the downlink signal information). For instance, the PIM noise detection model may be trained to output (1) indicators of whether instances of PIM noise are exhibited in the input data samples, and (2) for each of the input data samples for which a respective instance of PIM noise is indicated to be exhibited, downlink signal frequency information identifiers associated with source frequencies of the respective instance of PIM noise (e.g., identifying the frequencies that cause PIM noise, the carriers/frequencies that are involved (and whether they are 1^{st} order, 2^{nd} order, etc.), or the like). For instance, the PIM noise detection model may comprise a machine learning model, such as a supervised MLM, an unsupervised MLM, a deep learning model, a reinforcement learning model, a RNN, or a generative MLM (e.g., a generative adversarial network (GAN), or the like). In one example, the PIM noise detection model may be trained to output indicators of whether instances of PIM noise are exhibited in input data samples further based upon data of one or more external data sources. For instance, the external data may be relevant to PIM noise detection and can account for the way in which dissimilar metals may generate PIM noise in areas that have similar weather patterns, e.g., temperature, humidity, precipitation, salinity, etc.

At step 450, the processing system applies a first input data sample to the PIM noise detection model to obtain a first output comprising a first indication that a first instance of PIM noise is exhibited in the first input data sample, where the first input data sample comprises first downlink signal information associated with a cell site of the wireless communication network and first uplink noise information associated with the first downlink signal information (and thus also associated with the cell site and/or a specific sector of the cell site). In one example, the first input data sample may comprise a set of downlink signal information and uplink noise information over a period of time, e.g., a one minute time block, a 15 minute time block, a 30 minute time block, an hour, a day, a week, or the like. In one example, the first output may further include first downlink signal frequency information identifiers associated with first source frequencies of the first instance of PIM noise exhibited in the first input data sample. In one example, the first output may further comprise at least a first uplink frequency information identifier associated with at least a first frequency comprising the first instance of PIM noise. In one example, step 450 may include obtaining the first input data sample. For instance, the first input data sample may be obtained from a same portion of the wireless communication network as the training data. In one example, the first uplink noise information may be associated with a physical uplink shared channel. In one example, the first uplink noise information may be associated with uplink noise having a magnitude in excess of a predefined threshold. such as −100 dBm, −110 dBm, −115 dBm, −120 dBm, or the like (e.g., in one example, the present disclosure may evaluate for PIM noise/interference that is significant enough to warrant monitoring or remediation, or that is of higher priority than PIM noise that is of lesser magnitude). In one example, step 450 may further include obtaining external data and inputting the external data as additional inputs to the PIM noise detection model (e.g., weather data or the like, which may be particular to the time and location associated with the input data sample).

At step 460, the processing system performs at least one remedial action in the wireless communication network in response to the obtaining of the first indication that the first instance of passive intermodulation noise is exhibited in the first input data sample. In one example, the at least one remedial action may be performed further in response to the first downlink signal frequency information identifiers. To further illustrate, in one example, the at least one remedial action may include reducing a transmission energy in one or more of the first source frequencies. For instance, the wireless communication network can discover and can transmit less energy in those carriers, PRBs, channels/channel frequencies, or the like to mitigate intermodulation products. In this regard, it should be noted that in one example, transmitting less energy can include not utilizing a carrier, sub-carrier, frequency, frequency range, etc. for transmit/downlink. As noted above, in one example, the first output may include at least a first uplink frequency information identifier associated with at least a first frequency comprising the first instance of PIM noise. In such an example, the at least one remedial action may include omitting a utilization of the at least the first frequency for uplink communications (e.g., ceasing the use of one or more uplink carriers, sub-carriers, frequencies, frequency ranges, etc. that is/are affected by excessive PIM noise/interference). In one example, the at least one remedial action may include transmitting an alert to at least one of: an automated system of the wireless communication network or at least one endpoint device of a wireless communication network personnel, e.g., as an alternative or in addition to the foregoing other remedial actions mentioned.

In one example, step 460 may include transmitting one or more instructions to one or more components of the RAN, such as a CU, a DU, an RU (or an RRH, BBU, or the like). The instruction(s) may be to change one or more configurable settings of one or more of such components (which may be considered to be configurable settings of the RAN in which the components are deployed). For instance, the configurable settings can include selection of transmit power, antenna array tilt, beamwidth, etc., selection of precoding techniques, changes to thresholds for UE offloading and/or handover to neighboring cells, activation and deactivation of DUs and RUs, activation and deactivation of CUs, assignment of DUs to one or more CUs, allocation of physical resource, bandwidth, etc. to one or more network slices, and so forth. In one example, step 460 may further include transmitting one or more instructions to one or more other network components, such as an AMF, an NSSF, etc. For instance, reconfigurations of these components may be made in support of a change to at least one aspect of the RAN, such as offloading of UEs to a new network slice that may utilize certain cell sites and not others, and so forth.

In one example, step 460 may include selecting one or more types of remediation in response to the first downlink signal frequency information identifiers. For instance, in one example, step 460 may include applying an input vector comprising at least the downlink signal frequency information to a remediation selection model. In one example, the input vector may further include the first uplink noise information, e.g., the magnitude of PIM noise, frequencies affected and/or a frequency domain function indicative of noise in multiple frequencies/frequency bands, etc., and so forth. In one example, the input vector may alternatively or additionally include the cell/sector location information, information on the type of base station equipment (e.g., the manufacturer, model, series, etc.), other equipment information, e.g., manufacture date, deployment date, last serviced date, etc., weather/climate information of the cell, cell load information and/or other performance indicator data, and so forth. In one example, the remediation selection model may comprise an AI and/ML model that is configured to generate one or more remediation actions responsive to such types of input vectors. For instance, in one example, the remediation selection model may comprise a rule set, a decision tree, etc. In one example, the remediation selection model may comprise a generative model, e.g., a generative MLM that is trained/configured to generate one or more remediation actions in response to an input vector such as described above. To further illustrate, such a model may be trained with a training data set of input vectors and a set of corresponding available remedial actions such as any of the examples noted above, where each input vector in the training data set may be labeled with a corresponding “correct” remedial action and/or set of base station configuration settings/parameter values (and/or those of other relevant network equipment). In one example, such a training data set may be obtained from network records based upon network personnel manual actions. Alternatively, or in addition, such a model may comprise a reinforcement learning model in which different remedial actions, particular configuration setting/parameter values, etc. are selected and the corresponding network performance may be observed to note whether there is an improvement in one or more network performance indicators (e.g., comprising at least a reduction in PIM noise in the affected uplink PUCCH, PUSCH, etc.), and so forth. Following step 460, the method 400 proceeds to step 495 where the method 400 ends.

It should be noted that the method 400 may be expanded to include additional steps or may be modified to include additional operations with respect to the steps outlined above. In one example, various steps of the method 400 may be repeated for the same or different cell site, sector, or the like, for a different cell site or sector, and so forth. In one example, the method 400 may be expanded to further include training a generative model for synthetic training data generation at optional step 420. Likewise, in one example, the method 400 may further include training a remediation selection model that may be used at step 460. In one example, the method 400 may be expanded or modified to include steps, functions, and/or operations, or other features described above in connection with the example(s) of FIGS. 1-3, or as described elsewhere herein. Thus, these and other modifications are all contemplated within the scope of the present disclosure.

In addition, although not specifically specified, one or more steps, functions, or operations of the example method 400 may include a storing, displaying, and/or outputting step as required for a particular application. In other words, any data, records, fields, and/or intermediate results discussed in the method can be stored, displayed, and/or outputted either on the device executing the method or to another device, as required for a particular application. Furthermore, steps, blocks, functions or operations in FIG. 4 that recite a determining operation or involve a decision do not necessarily require that both branches of the determining operation be practiced. In other words, one of the branches of the determining operation can be deemed as an optional step. Furthermore, steps, blocks, functions or operations of the above described method(s) can be combined, separated, and/or performed in a different order from that described above, without departing from the examples of the present disclosure.

FIG. 5 depicts a high-level block diagram of a computing device or processing system specifically programmed to perform the functions described herein. As depicted in FIG. 5, the processing system 500 comprises one or more hardware processor elements 502 (e.g., a central processing unit (CPU), a microprocessor, or a multi-core processor), a memory 504 (e.g., random access memory (RAM) and/or read only memory (ROM)), a module 505 for performing at least one remedial action in a wireless communication network in response to obtaining a first indication that a first instance of passive intermodulation noise is exhibited in a first input data sample in accordance with a first output of a passive intermodulation noise detection model, and various input/output devices 506 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). In accordance with the present disclosure input/output devices 506 may also include antenna elements, antenna arrays, remote radio heads (RRHs), baseband units (BBUs), transceivers, power units, and so forth. Although only one processor element is shown, it should be noted that the computing device may employ a plurality of processor elements. Furthermore, although only one computing device is shown in the figure, if the method(s) as discussed above is/are implemented in a distributed or parallel manner for a particular illustrative example, i.e., the steps of the above method(s) is/are implemented across multiple or parallel computing devices, e.g., a processing system, then the computing device of this figure is intended to represent each of those multiple computing devices.

Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 502 can also be configured or programmed to cause other devices to perform one or more operations as discussed above. In other words, the hardware processor 502 may serve the function of a central controller directing other devices to perform the one or more operations as discussed above.

It should be noted that the present disclosure can be implemented in software and/or in a combination of software and hardware, e.g., using application specific integrated circuits (ASIC), a programmable gate array (PGA) including a Field PGA, or a state machine deployed on a hardware device, a computing device or any other hardware equivalents, e.g., computer readable instructions pertaining to the method discussed above can be used to configure a hardware processor to perform the steps, functions and/or operations of the above disclosed method(s). In one example, instructions and data for the present module or process 505 for performing at least one remedial action in a wireless communication network in response to obtaining a first indication that a first instance of passive intermodulation noise is exhibited in a first input data sample in accordance with a first output of a passive intermodulation noise detection model (e.g., a software program comprising computer-executable instructions) can be loaded into memory 504 and executed by hardware processor element 502 to implement the steps, functions, or operations as discussed above in connection with the illustrative method(s). Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method can be perceived as a programmed processor or a specialized processor. As such, the present module 505 for performing at least one remedial action in a wireless communication network in response to obtaining a first indication that a first instance of passive intermodulation noise is exhibited in a first input data sample in accordance with a first output of a passive intermodulation noise detection model (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette, and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of illustration only, and not a limitation. Thus, the breadth and scope of any aspect of the present disclosure should not be limited by any of the above-described examples, but should be defined only in accordance with the following claims and their equivalents.

What is claimed is:

1. A method comprising:
obtaining, by a processing system including at least one processor, a set of training records in a wireless communication network, wherein each training record of the set of training records comprises: downlink signal information, uplink noise information associated with the downlink signal information, and at least one label indicating whether passive intermodulation noise is present, wherein the wireless communication network utilizes a plurality of downlink carriers, wherein the set of training records is for different combinations of downlink carriers of the plurality of downlink carriers, and wherein the different combinations of downlink carriers comprise a subset of less than all possible combinations of the plurality of downlink carriers;
training, by the processing system, a passive intermodulation noise detection model in accordance with the set of training records, wherein the passive intermodulation noise detection model is trained to output indicators of whether instances of passive intermodulation noise are exhibited in input data samples;
applying, by the processing system, a first input data sample to the passive intermodulation noise detection model to obtain a first output comprising a first indication that a first instance of passive intermodulation noise is exhibited in the first input data sample, wherein the first input data sample comprises first downlink signal information associated with a cell site of the wireless communication network and first uplink noise information associated with the first downlink signal information; and
performing, by the processing system, at least one remedial action in the wireless communication network in response to the obtaining of the first indication that the first instance of passive intermodulation noise is exhibited in the first input data sample.

2. The method of claim 1, wherein the downlink signal information comprises a downlink signal information set that includes a plurality of downlink signal frequency information identifiers.

3. The method of claim 2, wherein the plurality of downlink signal frequency information identifiers comprise:
two or more channel frequencies;
two or more frequencies ranges that define two or more channels;
two or more sub-carrier range identifiers; or
two or more physical resource block identifiers.

4. The method of claim 2, wherein the downlink signal information set further includes:
two or more downlink signal magnitudes associated with two or more of the downlink signal frequency information identifiers.

5. The method of claim 1, wherein the uplink noise information comprises an uplink noise information set that includes:
one or more uplink frequency information identifiers; and
one or more uplink noise magnitudes associated with the one or more uplink frequency information identifiers.

6. The method of claim 5, wherein the one or more uplink frequency information identifiers comprise:
one or more channel frequencies;
one or more frequencies ranges that define one or more channels;
one or more sub-carrier range identifiers; or
one or more physical resource block identifiers.

7. The method of claim 1, wherein the first uplink noise information is associated with at least one of:
a physical uplink shared channel; or
a physical uplink control channel.

8. The method of claim 1, wherein the uplink noise information of each training record is associated with an uplink noise having a magnitude in excess of a pre-defined threshold.

9. The method of claim 1, wherein the passive intermodulation noise detection model is trained to output:
the indicators when the instances of passive intermodulation noise are exhibited in the input data samples; and
for each of the input data samples for which a respective instance of the passive intermodulation noise is indicated to be exhibited, downlink signal frequency information identifiers associated with source frequencies of the respective instance of the passive intermodulation noise.

10. The method of claim 9, wherein the first output further comprises first downlink signal frequency information identifiers associated with first source frequencies of the first instance of passive intermodulation noise exhibited in the first input data sample.

11. The method of claim 10, wherein the at least one remedial action is performed further in response to the first downlink signal frequency information identifiers.

12. The method of claim 11, wherein the at least one remedial action comprises reducing a transmission energy in the first source frequencies.

13. The method of claim 1, wherein the first output further comprises at least a first uplink frequency information identifier associated with at least a first frequency comprising the first instance of passive intermodulation noise, and wherein the at least one remedial action comprises omitting a utilization of the at least the first frequency for uplink communications.

14. The method of claim 1, further comprising:
generating synthetic training records based on at least a portion of the set of training records, wherein the synthetic training records that are generated are for combinations of downlink carriers that are not present in existing training records in the set of training records; and
adding the synthetic training records to the set of training records.

15. The method of claim 1, wherein the passive intermodulation noise detection model comprises a machine learning model.

16. The method of claim 15, wherein the machine learning model comprises:
a supervised machine learning model;
an unsupervised machine learning model;
a deep learning model;
a reinforcement learning model;
a recurrent neural network; or
a generative machine learning model.

17. The method of claim 1, wherein the passive intermodulation noise detection model is trained to output the indicators when the instances of passive intermodulation noise is exhibited in the input data samples is further based upon data of one or more external data sources.

18. The method of claim 1, wherein the at least one remedial action is selected via a generative model.

19. A non-transitory computer-readable medium storing instructions which, when executed by a processing system including at least one processor, cause the processing system to perform operations, the operations comprising:
obtaining a set of training records in a wireless communication network, wherein each training record of the set of training records comprises: downlink signal information, uplink noise information associated with the downlink signal information, and at least one label indicating whether passive intermodulation noise is present, wherein the wireless communication network utilizes a plurality of downlink carriers, wherein the set of training records is for different combinations of downlink carriers of the plurality of downlink carriers, and wherein the different combinations of downlink carriers comprise a subset of less than all possible combinations of the plurality of downlink carriers;
training a passive intermodulation noise detection model in accordance with the set of training records, wherein the passive intermodulation noise detection model is trained to output indicators of whether instances of passive intermodulation noise is exhibited in input data samples;
applying a first input data sample to the passive intermodulation noise detection model to obtain a first output comprising a first indication that a first instance of passive intermodulation noise is exhibited in the first input data sample, wherein the first input data sample comprises first downlink signal information associated with a cell site of the wireless communication network and first uplink noise information associated with the first downlink signal information; and
performing at least one remedial action in the wireless communication network in response to the obtaining of the first indication that the first instance of passive intermodulation noise is exhibited in the first input data sample.

20. An apparatus comprising:
a processing system including at least one processor; and
a computer-readable medium storing instructions which, when executed by the processing system, cause the processing system to perform operations, the operations comprising:
obtaining a set of training records in a wireless communication network, wherein each training record of the set of training records comprises: downlink signal information, uplink noise information associated with the downlink signal information, and at least one label indicating whether passive intermodulation noise is present, wherein the wireless communication network utilizes a plurality of downlink carriers, wherein the set of training records is for different combinations of downlink carriers of the plurality of downlink carriers, and wherein the different combinations of downlink carriers comprise a subset of less than all possible combinations of the plurality of downlink carriers;
training a passive intermodulation noise detection model in accordance with the set of training records, wherein the passive intermodulation noise detection model is trained to output indicators of whether instances of passive intermodulation noise is exhibited in input data samples;
applying a first input data sample to the passive intermodulation noise detection model to obtain a first output comprising a first indication that a first instance of passive intermodulation noise is exhibited in the first input data sample, wherein the first input data sample comprises first downlink signal information associated with a cell site of the wireless communication network and first uplink noise information associated with the first downlink signal information; and
performing at least one remedial action in the wireless communication network in response to the obtaining of the first indication that the first instance of passive intermodulation noise is exhibited in the first input data sample.
